(19) United States
(12) Patent Application Publication
(10) Pub. No.: US 2014/0313624 A1
(43) Pub. Date: Oct. 23, 2014

(54) SOLAR ENERGY CONVERSION APPARATUS

(71) Applicant: CHICONY POWER TECHNOLOGY CO., LTD., New Taipei City (TW)

(72) Inventors: Jyun-Ji CHEN, New Taipei City (TW); Wei-Shun HUANG, New Taipei City (TW)

(73) Assignee: Chicony Power Technology Co., Ltd., New Taipei City (TW)

(21) Appl. No.: 13/868,860

(22) Filed: Apr. 23, 2013

(51) Int. Cl. H02H 7/22; H02H 1/00

(52) U.S. Cl. CPC H02H 7/22; H02H 1/0007
USPC 361/45

(57) ABSTRACT

A solar energy conversion apparatus includes a solar energy conversion unit and a ground fault detection and interruption unit. The ground fault detection and interruption unit includes a switch subunit, a control subunit, and a leakage current sensing subunit. The control subunit is configured to turn off the switch subunit when the leakage current sensing subunit senses that a leakage current passing through the leakage current sensing subunit exceeds a predetermined leakage current threshold.

### BACKGROUND OF THE INVENTION

1. Field of the Invention

The present invention relates to a solar energy conversion apparatus, and especially relates to an improved solar energy conversion apparatus.

2. Description of the Related Art

Solar energy is freely and daily available. It is a clean, non-polluting source of energy. Additionally there is an enormous amount of solar energy provided by the sun to the surface of the earth that is available without significant environmental impact. The amount of solar energy impinging on the earth's surface in one hour is equivalent to the amount of energy consumed by mankind in one year, and amount of solar energy impinging at any particular area is a function of the atmospheric conditions and season change.

Solar energy is converted into electrical energy by a solar energy conversion apparatus. Therefore, the solar energy conversion apparatus is very important. However, a ground fault detection and interruption circuit of the related art solar energy conversion apparatus cannot detect and interrupt a leakage current fast.

### SUMMARY OF THE INVENTION

In order to solve the above-mentioned problems, an object of the present invention is to provide a solar energy conversion apparatus which is able to detect and interrupt a leakage current fast.

In order to achieve the object of the present invention mentioned above, the solar energy conversion apparatus is applied to a solar energy panel electrically connected to the solar energy conversion apparatus. The solar energy conversion apparatus includes a solar energy conversion unit electrically connected to the solar energy panel, and a ground fault detection and interruption unit electrically connected to the solar energy conversion unit. The ground fault detection and interruption unit includes a switch subunit, a control subunit, and a leakage current sensing subunit. The switch subunit is electrically connected to the solar energy conversion unit. The control subunit is electrically connected to the switch subunit. The leakage current sensing subunit is electrically connected to the switch subunit and the control subunit. The control subunit is configured to turn off the switch subunit when the leakage current sensing subunit senses that a leakage current passing through the leakage current sensing subunit exceeds a predetermined leakage current threshold.

Moreover, the ground fault detection and interruption unit further includes a fuse electrically connected to the leakage current sensing subunit and the control subunit, and an alarm subunit electrically connected to the control subunit. The solar energy conversion unit is a solar energy conversion circuit, a photovoltaic inverter, or a photovoltaic charger. The control subunit is a microcontroller. The leakage current sensing subunit is an inductor, a resistor, a current transformer, or a Hall current transformer. The alarm subunit is a light-emitting diode. The switch subunit is a metal oxide semiconductor field effect transistor (MOSFET), an insulation gate bipolar transistor (IGBT), a silicon controlled rectifier (SCR), or a bipolar junction transistor (BJT). The solar energy conversion unit includes a photovoltaic optimizer.

### BRIEF DESCRIPTION OF DRAWING

FIG. 1 shows a block diagram of the solar energy conversion apparatus of the present invention.

FIG. 2 shows how the leakage current is generated and how the leakage current is detected and interrupted by the present invention.

### DETAILED DESCRIPTION OF THE INVENTION

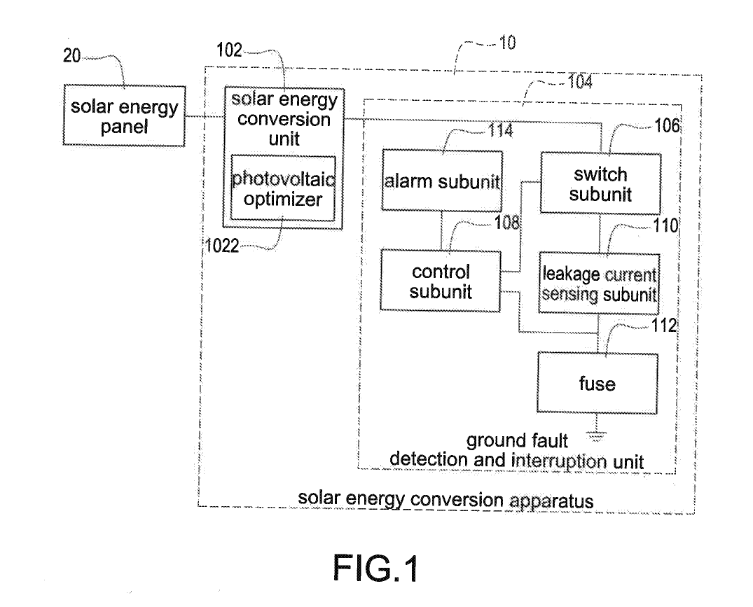

FIG. 1 shows a block diagram of the solar energy conversion apparatus of the present invention. A solar energy conversion apparatus 10 is applied to a solar energy panel 20 electrically connected to the solar energy conversion apparatus 10.

The solar energy conversion apparatus 10 includes a solar energy conversion unit 102, and a ground fault detection and interruption unit 104. The solar energy conversion unit 102 is electrically connected to the solar energy panel 20. The ground fault detection and interruption unit 104 is electrically connected to the solar energy conversion unit 102.

The ground fault detection and interruption unit 104 includes a switch subunit 106, a control subunit 108, a leakage current sensing subunit 110, a fuse 112, and an alarm subunit 114.

The switch subunit 106 is electrically connected to the solar energy conversion unit 102. The control subunit 108 is electrically connected to the switch subunit 106. The leakage current sensing subunit 110 is electrically connected to the switch subunit 106 and the control subunit 108. The fuse 112 is electrically connected to the leakage current sensing subunit 110 and the control subunit 108. The alarm subunit 114 is electrically connected to the control subunit 108.

The solar energy conversion unit 102 is, for example but not limited to, a solar energy conversion circuit, a photovoltaic inverter, or a photovoltaic charger. The control subunit 108 is, for example but not limited to, a microcontroller. The leakage current sensing subunit 110 is, for example but not limited to, an inductor, a resistor, a current transformer, or a Hall current transformer. The alarm subunit 114 is, for example but not limited to, a light-emitting diode. The solar energy conversion unit 102 includes a photovoltaic optimizer 1022.

The switch subunit 106 is, for example but not limited to, a metal oxide semiconductor field effect transistor (MOSFET), an insulation gate bipolar transistor (IGBT), a silicon controlled rectifier (SCR), or a bipolar junction transistor (MT).

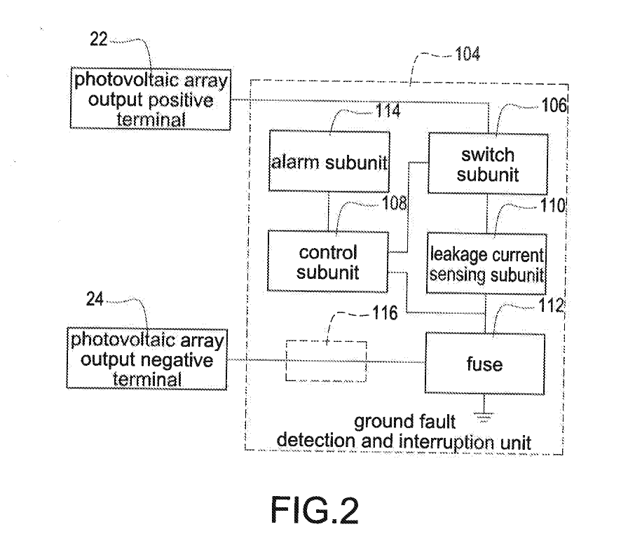

FIG. 2 shows how the leakage current is generated and how the leakage current is detected and interrupted by the present invention. There is no short circuit 116 when the insulation between a photovoltaic array output negative terminal 24 and the ground is not broken. There are the short circuit 116 and a leakage current when the insulation between the photovoltaic array output negative terminal 24 and the ground is broken.

The leakage current is passing from a photovoltaic array output positive terminal 22 to the photovoltaic array output negative terminal 24 through the switch subunit 106, the leakage current sensing subunit 110, the fuse 112, and the short circuit 116.

The control subunit 108 is configured to turn off the switch subunit 106 when the leakage current sensing subunit 110 senses that the leakage current passing through the leakage current sensing subunit 110 exceeds a predetermined leakage current threshold. Therefore, the solar energy conversion unit 102 stops working (stop converting solar energy into electrical energy). The solar energy conversion apparatus 10 is able to detect and interrupt the leakage current fast.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is

1. A solar energy conversion apparatus applied to a solar energy panel electrically connected to the solar energy conversion apparatus, the solar energy conversion apparatus including:
a solar energy conversion unit electrically connected to the solar energy panel; and
a ground fault detection and interruption unit electrically connected to the solar energy conversion unit,
wherein the ground fault detection and interruption unit includes:
a switch subunit electrically connected to the solar energy conversion unit;
a control subunit electrically connected to the switch subunit; and
a leakage current sensing subunit electrically connected to the switch subunit and the control subunit,
wherein the control subunit is configured to turn of the switch subunit when the leakage current sensing subunit senses that a leakage current passing through the leakage current sensing subunit exceeds a predetermined leakage current threshold.

2. The solar energy conversion apparatus in claim 1, wherein the ground fault detection and interruption unit further includes a fuse electrically connected to the leakage current sensing subunit and the control subunit.

3. The solar energy conversion apparatus in claim 2, wherein the ground fault detection and interruption unit further includes an alarm subunit electrically connected to the control subunit.

4. The solar energy conversion apparatus in claim 3, wherein the solar energy conversion unit is a solar energy conversion circuit, a photovoltaic inverter, or a photovoltaic charger.

5. The solar energy conversion apparatus in claim 4, wherein the control subunit is a microcontroller.

6. The solar energy conversion apparatus in claim 5, wherein the leakage current sensing subunit is an inductor, a resistor, a current transformer, or a Hall current transformer; the alarm subunit is a light-emitting diode.

7. The solar energy conversion apparatus in claim 6, wherein the switch subunit is a metal oxide semiconductor field effect transistor, an insulation gate bipolar transistor, a silicon controlled rectifier, or bipolar junction transistor.

8. The solar energy conversion apparatus in claim 7, wherein the solar energy conversion unit includes a photovoltaic optimizer.
